(19) United States
(12) Patent Application Publication
(10) Pub. No.: US 2013/0138413 A1
(43) Pub. Date: May 30, 2013

(54) System and Method for Determining Motion

(71) Applicant: Auckland Uniservices Limited, Auckland (NZ)

(72) Inventors: Mark Christopher Finch, Auckland (NZ); Thomas Oliver Lintern, Auckland (NZ); Poul Nielsen, Auckland (NZ); Andrew James Taberner, Auckland (NZ)

(73) Assignee: Auckland Uniservices Limited, Auckland (NZ)

(21) Appl. No.: 13/684,506

(22) Filed: Nov. 24, 2012

(30) Foreign Application Priority Data
Nov. 24, 2011 (NZ) 596655

(51) Int. Cl. G06F 17/50

(52) U.S. Cl. CPC G06F 17/5009
USPC 703/6

(57) ABSTRACT

A method of generating model motion data representing the predicted motion of a physical system based on sensed motion data from one or more motion sensors within the physical system. The method generates a stream of model motion data representing the predicted motion of the physical system based on a dynamic motion model of the physical system based on initial estimates of system parameters. The method then optimizes the system parameters of the dynamic motion model based on processing of the streams of model motion data and sensed motion data from one or more motion sensors within the physical system.

### FIELD OF THE INVENTION

The present invention relates to a system and method for determining motion of a physical system. In particular, although not exclusively, the system and method is may be applied to determining the motion of mechanical, electro-mechanical, and/or biomechanical systems, including human joint and/or limb movement.

### BACKGROUND TO THE INVENTION

Inertial motion capture systems are becoming increasingly prominent in today's market. They are often an attractive alternative to optically-based systems, which are expensive, susceptible to marker occlusion, and have limited capture areas. However, current inertia-based motion capture systems are often bulky and inaccurate.

Accuracy issues arise, particularly when calculating displacement. Inertial measurement units (IMU) typically output linear acceleration and rotational velocities which, when integrated, can provide estimates of linear displacement and angle, respectively. However, simple integration of the accelerations and rotational velocities compounds errors, causing the predicted position of the sensor to drift from its true value.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide an improved system and method for determining the motion of a physical system, or to at least provide the public with a useful choice.

### SUMMARY OF THE INVENTION

In a first aspect, the present invention broadly consists in a method of generating model motion data representing the predicted motion of a physical system based on sensed motion data from one or more motion sensors within the physical system, comprising:
generating a stream of model motion data representing the predicted motion of the physical system based on a dynamic motion model of the physical system which comprises initial estimates of system parameters;
receiving a stream of sensed motion data representing the measured motion within the physical system as sensed by the one or more motion sensors within the physical system;
optimizing the system parameters of the dynamic motion model based on processing of the streams of model motion data and sensed motion data; and
outputting the model motion data from the dynamic motion model based on the optimized system parameters.

Preferably, the dynamic motion model of the physical system comprises a physical system model defined by equations of motion corresponding to the physical system. More preferably, the equations of motion are derived for the physical system from first principles using classical mechanics (e.g. Lagrangian, Hamiltonian or Newtonian). The physical system model may comprise one or more unknown system parameters (degrees of freedom) for which initial estimates are provided.

Preferably, generating model motion data comprises solving the equations of motion of the physical system model to generate one or more time-dependent model motion data variables. More preferably, the model motion data variables may represent any position and/or orientation parameter relating to the motion within the physical system. By way of example, the position model motion data variables may represent position, velocity, and/or acceleration and the orientation model motion data variables may represent angular position, angular velocity, and/or angular acceleration. It will be appreciated that the model motion data variables may be derivable from each other based on time derivatives or time integrals.

Preferably, the physical system comprises one or more motion sensors located or mounted on moving features within the physical system and which are configured to sense or measure motion of those moving features within the physical system to generate sensed motion data. More preferably, the sensed motion data represents one or more sensed motion data variables representing motion within the physical system. By way of example, the motion sensors may comprise one or more inertial sensors, such as accelerometer sensors, gyroscope sensors, or a combination of these in the form of inertial measurement units (IMU).

In one embodiment, each motion sensor comprises:
an accelerometer configured to sense acceleration and generate sensed motion data variables representing acceleration within the physical system;
a magnetometer configured to sense magnetic field strength and generate sensed motion data variables representing magnetic field strength within the physical system; and
a gyroscope configured to sense angular velocity and generate sensed motion data variables representing angular velocity within the physical system.

Additionally, each motion sensor may comprise a global positioning system (GPS) sensor or module that is configured to sense position and/or linear velocity and generate sensed motion data variables representing the position and/or linear velocity within the physical system.

Each motion sensor(s) may be in the form of an accelerometer sensor, magnetometer sensor, gyroscope sensor, or GPS sensor, either alone or in any combination, and each sensor may be configured to measure along 1, 2, or 3 axes, and where the axes are typically orthogonal with respect to each other.

In some embodiments, the method may further comprise receiving a stream of supplementary sensed motion data representing measured or sensed motion within the physical system from one or more supplementary motion sensor systems. The motion sensor systems may be fully ‘onboard’ the moving features within the system, external to the physical system, or motion sensing systems that require interactive components that are onboard and external to the physical system. By way of example, the supplementary motion sensor system may be configured to measure any aspect of position and/or orientation, each in up to six degrees of freedom with respect to up to three orthogonal axes. By way of example, the supplementary motion sensor systems may include, but are not limited to, any one or more of the following:
optical motion capture systems,
radio frequency motion capture systems,
ultrawide broadband motion capture systems,
ultrasonic motion capture systems, or
any other position and/or orientation sensing or tracking system.

Preferably, the dynamic motion model of the physical system further comprises a motion sensor relationship model that is configured to model the relationship between the model motion data (e.g. model motion data variables) from the physical system model and the sensed motion data (e.g. the sensed motion data variables) from the one or more motion sensors and any supplementary motion sensor systems. More preferably, the motion sensor relationship model is based on kinematic equations that relate the model motion data to the sensed motion data. The kinematic equations may comprise one or more unknown system parameters for which initial estimates are provided.

Preferably, optimizing the system parameters of the dynamic motion model (e.g. within the physical system model and motion sensor relationship model) comprises applying an objective function to the stream of model motion data and sensed motion data to generate optimized system parameters. More preferably, the objective function is configured to compare the model motion data to the sensed motion data based on the motion sensor relationship model and to optimize the system parameters within the dynamic motion model to reduce any error between the model motion data and sensed motion data.

Preferably, optimizing the system parameters comprises continuously or periodically optimizing the system parameters based on the continuous streams of model motion data and sensed motion data.

In a second aspect, the present invention broadly consists in a method of modeling motion of a physical system using sensed motion data from one or more motion sensors within the physical system, comprising:
determining equations of motion defining the predicted motion within the physical system, the equations of motion comprising initial estimates of system parameters;
solving the equations of motion to generate model motion data representing predicted motion within the physical system;
determining kinematic equations for relating the model motion data from the equations of motion to the sensed motion data from the one or more motion sensors, the kinematic equations comprising initial estimates of one or more system parameters; and
optimizing the system parameters of the equations of motion and kinematic equations to reduce the error between the model motion data and sensed motion data to thereby improve the accuracy of the model motion data.

The second aspect of the invention may have any one or more features mentioned in respect of the first aspect of the invention, and vice versa.

In a third aspect, the present invention broadly consists in a motion assessment system for generating model motion data representing the predicted motion within a physical system, comprising:
a dynamic motion model sub-system that is configured to generate a stream of model motion data representing the predicted motion of the physical system based on a dynamic motion model of the physical system, the dynamic motion model being configured by model configuration data defining the dynamic motion model of the physical system being assessed and initial estimates of model system parameters;
one or more motion sensors within the physical system that are configured to measure motion within the physical system and generate a stream of sensed motion data representing the measured motion; and
an optimization sub-system configured to receive and process the streams of model motion data and sensed motion data so as to optimize the model system parameters of the dynamic motion model to improve the accuracy of the model motion data.

Preferably, the physical system comprises one or more motion sensors located or mounted on moving features within the physical system and which are configured to sense or measure motion of those moving features within the physical system to generate sensed motion data. More preferably, the sensed motion data represents one or more sensed motion data variables representing motion within the physical system. By way of example, the motion sensors may comprise one or more inertial sensors, such as accelerometer sensors, gyroscope sensors, or a combination of these in the form of inertial measurement units (IMU).

In one embodiment, each motion sensor comprises:
an accelerometer configured to sense acceleration and generate sensed motion data variables representing acceleration within the physical system;
a magnetometer configured to sense magnetic field strength and generate sensed motion data variables representing magnetic field strength within the physical system; and
a gyroscope configured to sense angular velocity and generate sensed motion data variables representing angular velocity within the physical system.

Additionally, each motion sensor may comprise a global positioning system (GPS) sensor or module that is configured to sense position and/or linear velocity and generate sensed motion data variables representing the position and/or linear velocity within the physical system.

Each motion sensor(s) may be in the form of an accelerometer sensor, magnetometer sensor, gyroscope sensor, or GPS sensor, either alone or in any combination, and each sensor may be configured to measure along 1, 2, or 3 axes, and where the axes are typically orthogonal to each other.

In some embodiments, the method may further comprise receiving a stream of supplementary sensed motion data representing measured or sensed motion within the physical system from one or more supplementary motion sensor systems. The motion sensor systems may be fully ‘onboard’ the moving features within the system, external to the physical system, or motion sensing systems that require interactive components that are onboard and external to the physical system. By way of example, the supplementary motion sensor system may be configured to measure any aspect of position and/or orientation, each in up to six degrees of freedom with respect to up to three orthogonal axes. By way of example, the supplementary motion sensor systems may include, but are not limited to, any one or more of the following:
optical motion capture systems,
radio frequency motion capture systems,
ultrawide broadband motion capture systems,
ultrasonic motion capture systems, or
any other position and/or orientation sensing or tracking system.

Preferably, the model configuration data defines a dynamic motion model comprising:
a physical system model that is configured to generate the model motion data representing the predicted motion of the physical system; and
a motion sensor relationship model that is configured to define the relationship between the model motion data of the physical system model and the sensed motion data from the motion sensor(s) and any supplementary motion sensor systems.

Preferably, the optimization sub-system is configured to apply an objective function to the model motion data and sensed motion data and generate optimized model system parameters that reduce any error between the motion as represented by the model motion data and sensed motion data.

In a fourth aspect, the present invention broadly consists in a motion modeling device for modeling the motion of a physical system, comprising:
an input interface configured to receive a stream of sensed motion data from one or more motion sensors within the physical system that are configured to sense motion within the physical system;
a signal processor configured to generate a stream of model motion data representing the predicted motion within the physical system based on a dynamic motion model of the physical system, the dynamic motion model being configured by stored model configuration data defining the dynamic motion model of the physical system and stored initial estimates of system parameters within the dynamic motion model, the signal processor being configured to update the system parameters of the dynamic motion model with optimized system parameters generated based on processing of the streams of model motion data and sensed motion data;
memory configured to store system data used and processed by the signal processor; and
an output interface configured to output the model motion data.

Preferably, the signal processor is configured to continuously or periodically update the system parameters of the dynamic motion model with optimized system parameters.

Preferably, the signal processor is configured to apply an objective function to the streams of model motion data and sensed motion data and generate the optimized system parameters that reduce any error between the motion as represented by the model motion data and sensed motion data.

The fourth aspect of the invention may have any one or more of the features mentioned in respect of the third aspect of the invention, and vice versa.

The phrase “physical system” as used in this specification and claims is intended to mean, unless the context suggests otherwise, any type of physical system that exhibits motion, whether mechanical, electro-mechanical, biomechanical such as movement of limbs, joints or other parts of human body, or any other physical system, and wherein the physical system may have one or multiple different moving parts, components or features, and which may have one or multiple degrees of freedom of movement and where the multiple parts, components or features may or may not be interconnected or linked within the physical system.

The phrase “motion data” as used in this specification and claims is intended to mean, unless the context suggests otherwise, any data or signal representing an aspect of motion, movement, position and/or orientation of a moving feature or features within a physical system, and may be represented by position and/or orientation relative to one or multiple axes, and for example represent motion of a feature in any one of or up to 6 degrees of freedom, such as 3D position with respect to 3 orthogonal axes (e.g. forward and backward, side to side, and up and down) and 3D orientation with respect to angular movement relative to 3 axes (e.g. yaw, pitch, and roll).

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

The invention consists in the foregoing and also envisages constructions of which the following gives examples only.

### BRIEF DESCRIPTION OF THE DRAWINGS

Preferred embodiments of the invention will be described by way of example only and with reference to the drawings, in which:

FIG. 1 is a schematic block diagram of a motion assessment system in accordance with an embodiment of the invention;

FIG. 2 is a schematic block diagram of a motion modeling device in accordance with an embodiment of the invention;

FIG. 3 is a flow diagram of a method of generating model motion data representing predicted motion of a physical system in accordance with an embodiment of the invention;

FIG. 4a shows a perspective view of an experimental configuration for an experimental example of an implementation of the motion assessment system for assessing motion of a swinging pendulum;

FIG. 4b is a schematic diagram of the motion data variables being assessed in the experiment of FIG. 4a;

FIG. 5a is a plot of the experimental results comparing the tangential acceleration measured by the accelerometer of the motion sensor on the pendulum and that predicted by the model in the experiment of FIG. 4a;

FIG. 5b shows a plot comparing the normal acceleration measured by the accelerometer of the motion sensor to that predicted by the model in the experiment of FIG. 4a;

FIG. 6a shows a plot comparing the pendulum angle as measured by the magnetometer of the motion sensor and that predicted by the model in the experiment of FIG. 4a;

FIG. 6b shows a plot comparing the angular velocity of the pendulum as measured by the gyroscope of the motion sensor to that predicted by the model in the experiment of FIG. 4a;

FIG. 7a shows a plot comparing the pendulum angle measured by the magnetometer of the motion sensor to that measured by an encoder in the experiment of FIG. 4a;

FIG. 7b shows a plot comparing the pendulum angle predicted by the model to that measured by an encoder in the experiment of FIG. 4a;

FIG. 8 is a schematic diagram of a five-bar linkage kinematic model for a cycling application of the motion assessment system and indicating distances of interest; and

FIG. 9 shows a schematic diagram of a four-link kinematic model for a cycling application of the motion assessment system and showing angles of interest.

### DETAILED DESCRIPTION OF PREFERRED EMBODIMENTS

### Overview

The present invention relates to a system and method for modelling and assessing the motion of a physical system and optimizing the modelling of that physical system based on real measured motion data from motion sensors provided within the physical system. The physical system may be any type or form of real-world system that comprises moving parts, components or features whether interlinked or independent from each other, and including mechanical systems, electro-mechanical systems, biomechanical systems such as movement of limb or parts of a human body.

The system and method may be implemented in software, hardware or a combination of these. In particular, the methods and algorithms may be implemented by any form of programmable device, such as a digital signal processor, microprocessor, microcontroller or any other suitable programmable device or computer-implementation, including on a general purpose Personal Computer. Further, a motion assessment system may be provided in a configurable form ready for assessing any type of physical system by way of configuration data that customises the system for assessing the particular physical system. Alternatively, standalone and dedicated motion assessment devices may be provided that are preconfigured or programmed for assessing motion of a particular physical system. Embodiments of the systems and devices will be described by way of example only and it will be appreciated that the systems and devices may be varied depending on design requirements and the physical system being assessed.

### Motion Assessment System

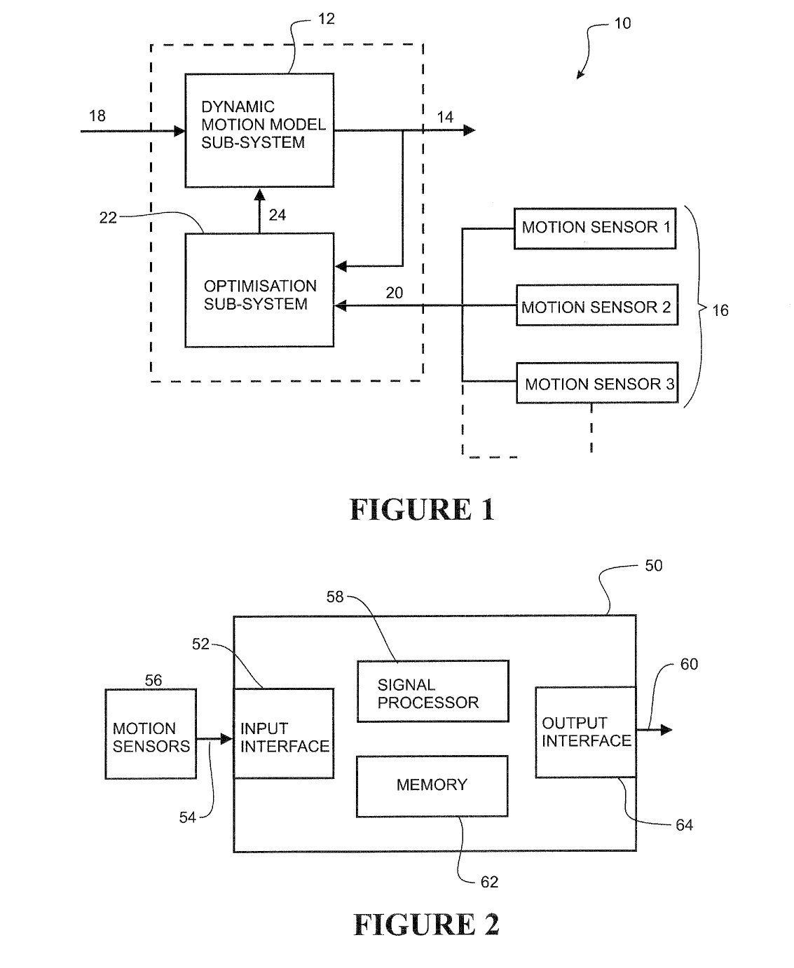

Referring to FIG. 1, an embodiment of motion assessment system 10 is shown. The system 10 comprises a dynamic motion model sub-system 12 that is configured to generate a stream of model motion data 14 representing the predicted motion of the physical system being assessed based on a dynamic motion model of the physical system. In this embodiment, the dynamic motion model comprises two-parts. Firstly, a physical system model is provided that is configured to generate the model motion data 14 representing the predicted motion of the physical system. As will be explained in further detail later, the physical system model is generated and defined by equations of motion derived for the physical system based on first principles. The physical system model also comprises initial estimates of system parameters within those equations of motion. Secondly, the dynamic motion model comprises a motion sensor relationship model that is configured to define the relationship between the model motion data generated by the physical system model and the sensed motion data from motion sensors 16 within the physical system. In this embodiment, the motion sensor relationship model is defined by kinematic equations that relate the model motion data to the sensed motion data and the kinematic equations may comprise one or more system parameters to which initial estimates are provided. By way of example, the motion sensor relationship model may be configured to convert the model motion data into a format corresponding to the output format of the sensor motion data from the motion sensors.

In this embodiment, the system 10 is configurable for any desired physical system and the dynamic motion model sub-system 12 is configured by model configuration data 18 input into the system.

As mentioned, the motion assessment system 10 is configured to receive sensed motion data 20 from one or more motion sensors located within the physical system and which are configured to sense motion variables corresponding to or which are convertable into a form or format corresponding to those being assessed by the dynamic motion model.

The complexity of the physical system being modelled and the number of aspects or motion variables being assessed defines the required number of motion sensors needed in the physical system. In simple physical systems or where only a single aspect of motion is being assessed, a single motion sensor may be adequate whereas in more complex physical systems two or multiple motion sensors may be required. In this embodiment, the motion sensors comprise one or more inertial sensors. In preferred embodiments, the motion sensors comprise: an inertial measurement unit (IMU) having an accelerometer sensor and a gyroscope sensor; and a magnetometer sensor. More preferably, a GPS sensor may also be provided in each motion sensor. In other embodiments, the motion sensor(s) may be in the form of an accelerometer sensor, magnetometer sensor, gyroscope sensor, or GPS sensor in their own right, or any combination of these sensors. The sensors may have single axis sensing capability or multiple axis sensing capability, and typically comprise three axis sensing capability.

In this preferred embodiment, the motion sensors above are ‘onboard’ motion sensors in that they are mounted attached or fixed, either temporarily or permanently, to the moving features being assessed within the physical system. In some embodiments of the motion assessment system, supplementary motion sensing systems may be provided in addition to the primary on board motion sensors within the physical system.

In some embodiments, the method may further comprise receiving a stream of supplementary sensed motion data representing measured or sensed motion of the moving features within the physical system from one or more supplementary motion sensor systems. The motion sensor systems may be fully ‘onboard’ the moving features within the system, external to the physical system, or motion sensing systems that require interactive components that are onboard and external to the physical system. By way of example, the supplementary motion sensor system may be configured to measure any aspect of position and/or orientation, each in up to six degrees of freedom with respect to up to three orthogonal axes. By way of example, the supplementary motion sensor systems may include, but are not limited to, any one or more of the following:
optical motion capture systems,
radio frequency motion capture systems,
ultrawide broadband motion capture systems,
ultrasonic motion capture systems, or
any other position and/or orientation sensing or tracking system.

The system 10 further comprises an optimization sub-system 22 that is configured to receive and process the streams of model motion data 14 from the dynamic motion model sub-system 12 and the sensed motion data 20 from the motion sensor(s) 16 and any supplemental motion sensor systems so as to optimize the model system parameters within the dynamic motion model to improve the accuracy of the model motion data 14. In this embodiment, as will be explained in further detail later, the optimization sub-system 22 is configured to apply and objective function to the model motion data 14 and sensed motion data 20 and generates optimized model system parameters that reduce any error between the motion as represented by two streams of motion data 14, 20. The updated or optimized system parameters 24 are input into the dynamic motion model sub-system 12 to update the dynamic motion model as required and improve the accuracy of the model motion data output. The optimization sub-system preferably continuously processes the streams of motion data 14, 20 and continuously updates the system parameters 24 as required. However, the optimization sub-system may operate on a periodic basis or user initiated basis in alternative embodiments.

### Motion Modelling Device

Referring to FIG. 2, an embodiment of a motion modelling device 50 will be explained. The motion modelling device is preconfigured for assessing a modelling motion of a particular physical system but otherwise operates in a manner substantially similar to the motion assessment system described with respect to FIG. 1 above. The device 50 may be any form of customised stand-alone electronic device or system or alternatively may be implemented on a general programmable device, such as a Personal Computer. In the preferred embodiment, the device 50 comprises an input interface 52 that is configured to receive a stream of sensed motion data 54 from one or more motion sensors 56 provided within the physical system and which are configured to sense or measure motion within the physical system. A signal processor 58 is provided and is configured to generate a stream of model motion data 60 representing the predicted motion of the physical system based on a dynamic motion model of the physical system. The dynamic motion model for the physical system is defined or configured by model configuration data stored in memory 62 along with stored initial estimates of system model parameters. Additionally, the signal processor 58 is configured to update the system parameters of the dynamic motion model with optimized system parameters generated based on processing of the streams of model motion data 60 and sensed motion data 54. As with the system 10 of FIG. 1, the optimized system parameters are generated based on the application of objective function being applied to the model motion data 60 and sensed motion data 54 so as to produce parameters that reduce or minimise any error between the motion as represented by the two data streams 54, 60. An output interface 64 is also provided for outputting the model motion data 60.

It will be appreciated that the input and output interfaces 52, 64 may comprise any typical signal processing functionality such as digital-to-analogue or analogue-to-digital conversion and the like. Further, the motion sensors 56 may be hardwired to the device 50 or may alternatively wirelessly transmit sensed motion data via a wireless communication link with the motion modelling device 50.

### Process of Modelling Motion Data of a Physical System

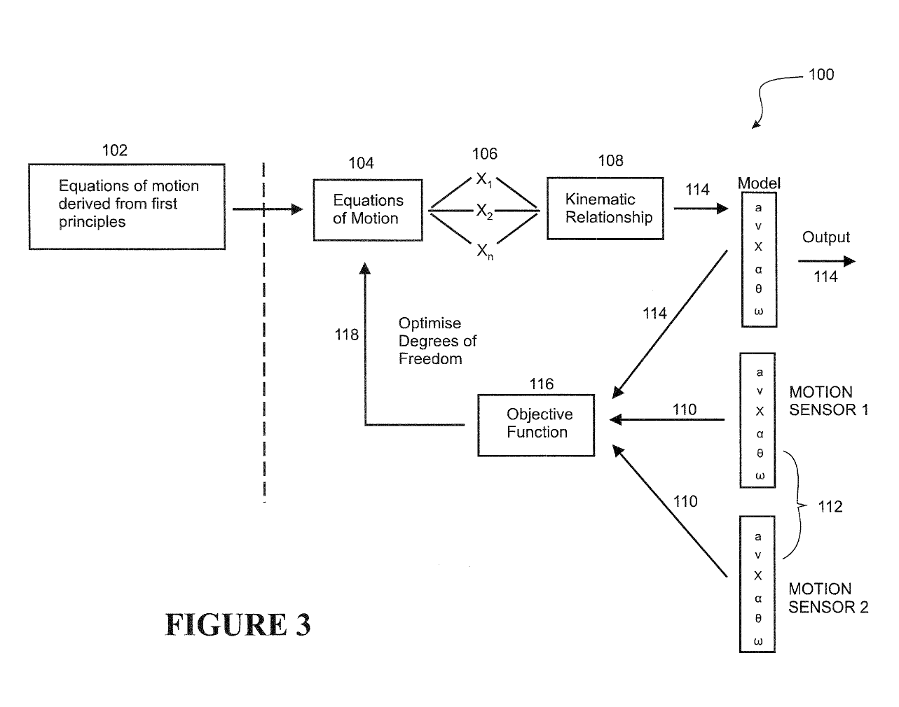

The hardware associated with the various embodiments of the motion assessment or capture system and device have been described with reference to FIGS. 1 and 2. The underlying process 100 or algorithm and flow of data in these systems and the method of generating accurate model motion data for a physical system will now be explained in further detail with reference to FIG. 3.

Referring to FIG. 3, for any given physical system for which motion is to be assessed or modelled, the first step 102 in the process is determining a dynamic motion model of the physical system and models motion data variables being assessed. The model motion data variables may represent any position and/or orientation parameters that define the desired motion or movement of features to be modelled or assessed within the physical system and are often time-dependent model motion data variables. By way of example, the position model motion data variables may represent position, velocity and/or acceleration of features, components or parts in the physical system with respect to either a single axis, twin axes or multiple axes. Likewise, the orientation model motion data variables may represent angular position, angular velocity, and/or angular acceleration with respect to a single axis, twin axes or multiple axes. Further, different motion data variables may be extracted or derived from other motion data variables, whether via time-integrals, time-derivatives or other modelling motion equations.

In this embodiment, the motion sensors 112 are configured to provide sensed motion data representing the following variables, with respect to either a single axis, twin axes or multiple (e.g. 3 or more) axes:
a=acceleration,
v=linear velocity,
x=position,
α=angular acceleration,
θ=angular position, and
ω=angular velocity.

By way of example, it will be appreciated that the acceleration (a) may be measured by an accelerometer sensor, with the velocity (v) and position (x) being derivable from time integrals of the acceleration. Likewise, it will be appreciated that the angular velocity (ω) may be sensed directly by a gyroscope sensor with the angular position (θ) and angular acceleration (α) being derived from time integrals with time derivatives of the angular velocity. The angular position (θ) may additionally or alternatively be sensed or measured directly by a magnetometer sensor. Likewise, a GPS sensor may be configured to directly sense linear velocity (v) and position (x).

In this embodiment, the dynamic motion model is defined by equations of motion determined for the physical system. In particular, the first step of the process 100 at 102 comprises deriving mathematical equations of motion for the physical system from first principles. In this embodiment, the equations of motion are generated using Lagrangian mechanics with defined generalized coordinates, but in alternative embodiments Newton's methods and techniques may be employed to derive corresponding equations of motion. As previously explained, the complexity of the equations of motion are dependent on the complexity of the physical system being modeled, including but not limited to the range of movement, degrees of freedom of movement, axes of movement, and whether there are two or more moving features, interlinked or otherwise, being assessed, although other factors also determine the complexity of the equations of motion.

The next step 104 in the process 100 is solving the equations of motion to generate a stream of model motion data comprising motion data variables that represent the predicted motion within the physical system. In particular, solving the equations of motion 104 derived at step 102 comprises solving the equations for motion data variables comprising the generalized coordinates and their time derivatives.

At step 108, kinematic equations are determined for relating the model motion data 106 to the sensed motion data 110 measured and generated by the one or more motion sensors 112 within the physical system. In this embodiment, the kinematic relationships define a motion sensor relationship model that is configured to model the relationship between the model motion data from the equations of motion with the sensed motion data from the motion sensor(s). At step 108, the model motion data 106 is converted into a modified data stream 114 that is equivalent or corresponds in format to the data variables sensed by the motion sensors 112. The model motion data 114 represents the output of the process 100 and the predicted and modeled motion of the physical system being assessed.

The process 100 also comprises an optimization process. In this embodiment, the model motion data 114 and corresponding sensed motion data 110 from the motion sensor(s) 112 is continually fed into an optimization step 116, along with any supplemental sensor motion data from any supplementary motion sensor systems. The optimization step 116 receives and processes the model motion data 114 and sensed motion data 110 and generates optimized system parameters 118 for updating the initial estimates of system parameters in the dynamic motion model of the physical system. The optimized system parameters may form part of the equations of motion (i.e. the physical system model) and the kinematic relationship (i.e. the motion sensor relationship model). The optimization step 116 in this embodiment is configured to apply an objective function to compare the model motion data 114 to the sensed motion data 110 with the objective of varying the system parameters to reduce or minimize any error or difference between the two sets of corresponding data 114, 110. It will be appreciated that the optimization step 116 may use linear or non-linear optimization techniques, and this may be dependent on the order of the objective function. In this embodiment, the optimization step 116 is configured to minimize the RMS error of the objective function derived from the model motion data 114 and measured or sensed motion data 110 by optimizing the specified system parameters or degrees of freedom (unknowns) in the equations of motion and/or kinematic relationship.

### Experimental Example

### Swinging Pendulum

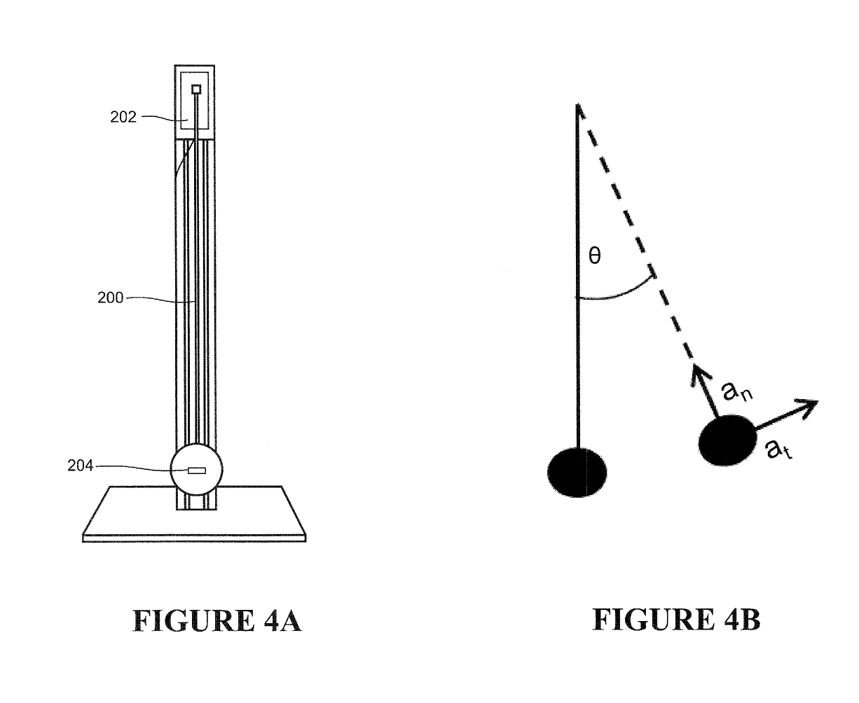

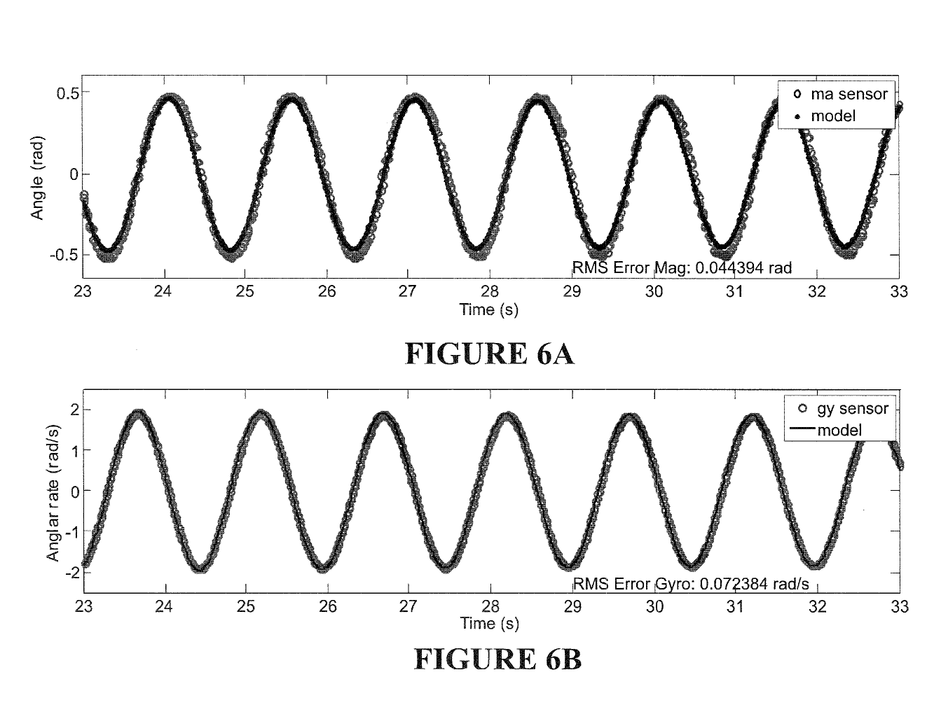

With reference to FIGS. 4a-7b, an experiment showing the implementation of the motion sensing system and method for a physical system comprising an instrumented two-dimensional pendulum will be described. The example is not intended to be limiting.

Referring to FIG. 4a, a simple pendulum was constructed consisting of a lightweight aluminum rod 200 mounted to a rotary encoder 202 (pendulum joint) and a brass mass 204 fastened to the bottom of the rod. A single motion sensor was placed at a selected position on the pendulum arm (measured distance of 0.534 m from the pivot) and aligned with the axis of the arm. The rotary encoder 202 had a 0.25° (0.00436 rad) resolution, and a sampling frequency of 100 Hz. FIG. 4b shows a schematic diagram illustrating the angle and acceleration components measured in the experiment, in particular tangential acceleration aₜ, normal acceleration aₙ, and angular position θ.

In this experiment, the motion sensor was an inductively-rechargeable nine-axis wireless motion sensor, comprising an inertial measurement unit (IMU). The motion sensor was capable of measuring linear accelerations in three axes, angular rates about three axes, and magnetic field strength in three axes. The controlling chipset used a Nordic 2.4 GHz nRF24E1 wireless transceiver that streams data wirelessly to a receiver connected to a host computer. The device has wireless power transfer capabilities, allowing the battery to be recharged by placing the chip onto a ‘charge pad’. The charge pad produces an alternating magnetic field which then induces a current in the chip that will recharge the battery. The wireless power transfer enables the chipset to be hermetically sealed, thereby waterproofing the sensor. The motion sensor was 22 mm×34 mm×10 mm in size and had a mass of approximately 12 g.

The accelerometer (ADXL345) had a configurable range (±20 ms⁻², ±40 ms⁻², ±80 ms⁻², ±160 ms⁻²) but for the experiment was set to ±160 ms⁻². The gyroscopes (IDG650 and IXZ650) had a range of ±2000°/s, while the range of the magnetometer (HMC5843) could be varied from ±70 μT to ±650 μT. Although the Earth's magnetic field strength is typically between 30 μT and 60 μT, there can be large offsets imposed on the magnetometer, whether it be surrounding metals or biases in the sensing mechanism. The magnetometer was set to ±150 μT to ensure that the field strength didn't saturate the sensor.

The 3-axis gyroscope and 3-axis accelerometer were both sampled at 500 Hz. The gyroscope were sampled by an on board analog-to-digital converter (ADC) interfaced through an inter-integrated circuit (I2C) protocol, while the accelerometer measurements were returned via a serial peripheral interface (SPI). Magnetic field estimates are returned from the 3-axis magnetometer via 12C at a sample rate of 50 Hz.

It will be appreciated that the experiment may have optionally employed a motion sensor additionally comprising a GPS sensor being configured to measure position and/or linear velocity directly to enhance the results. The GPS sensor may have been sampled at any desired sampling rate, but typically would be sampled at a lower rate (e.g. 10 Hz) compared to the higher sampling rates in the gyroscope, accelerometer, and magnetometer.

The physical system model comprising the equations of motion of a pendulum were derived using Lagrangian mechanics and are shown in Equation (2),

$$\ddot{θ} = \frac{- ϕ}{{l}_{com}^{2} m} \dot{θ} + \frac{- g}{{l}_{com}} sin θ \qquad ( 2 )$$

Where θ, \dot{θ}, and \ddot{θ} are the angle, and time derivatives of the angle with respect to the vertical axis of the pendulum (shown in FIG. 4b); φ is the damping coefficient of the joint; l_{com} is the length from the joint to the center of mass; g is the acceleration due to gravity; t is time. The pendulum was assumed to consist of a point mass on the end of a massless rod.

Using the geometry of the pendulum, kinematic relationships (Equations 3 and 4) can be used to directly relate measurements taken from the sensors (aₜ, aₙ, \dot{θ}, and θ) to the equivalent numerical solutions of Equation (2). Note that the solutions θ, \dot{θ} from Equation 2 can already be related directly to the measured θ, \dot{θ}.

aₜ=lₛₑₙₛ\ddot{θ}+g sin θ (3)

aₙ=−lₛₑₙₛ(\dot{θ})²−g cos θ (4)

Where aₜ is the tangential acceleration measured at the sensor (as shown in FIG. 4b); lₛₑₙₛ is the length from the joint to the sensor; aₙ is the normal acceleration measured at the sensor (FIG. 4b).

Solving the equations of motion (Equation (2)) results in estimates of θ, \dot{θ}, and \ddot{θ} which can then be compared directly to the measurements (X₍ₛₑₙₛₒᵣ₎ᵢⱼ) using the kinematic relations in Equations 3 and 4. The model predictions (X_{(model)ij}) and the measurements (X₍ₛₑₙₛₒᵣ₎ᵢⱼ) were combined in an objective function, shown in Equation (5),

$$\sqrt{{\sum }_{i = 1}^{4} {\sum }_{j = 1}^{n} [ \frac{{( {X}_{( model ) ij} - {X}_{( sensor ) ij} )}^{2}}{{σ}_{( sensor ) ij}^{2}} ] / n} \\ where \\ {X}_{( model ) ij} = \{ \begin{matrix}{a}_{t ( model ) j} & i = 1 \\ {a}_{n ( model ) j} & i = 2 \\ {\dot{θ}}_{( model ) j} & i = 3 \\ {θ}_{( model ) j} & i = 4\end{matrix} \} for sample j = 1 … n \\ {X}_{( sensor ) ij} = \{ \begin{matrix}{a}_{t ( sensor ) j} & i = 1 \\ {a}_{n ( sensor ) j} & i = 2 \\ {\dot{θ}}_{( sensor ) j} & i = 3 \\ {θ}_{( sensor ) j} & i = 4\end{matrix} \} for sample j = 1 … n \qquad ( 5 )$$

and σ₍ₛₑₙₛₒᵣ₎ᵢⱼ is the standard deviation of X₍ₛₑₙₛₒᵣ₎ᵢⱼ. σ₍ₛₑₙₛₒᵣ₎ᵢⱼ was used to non-dimensionalize the objective function to ensure that measurements with different units were weighted correctly. The RMS error between the two data sets was minimized by optimizing the degrees of freedom or system parameters of the system, which were: l_{com}, lₛₑₙₛ, and φ.

### Experimental Results

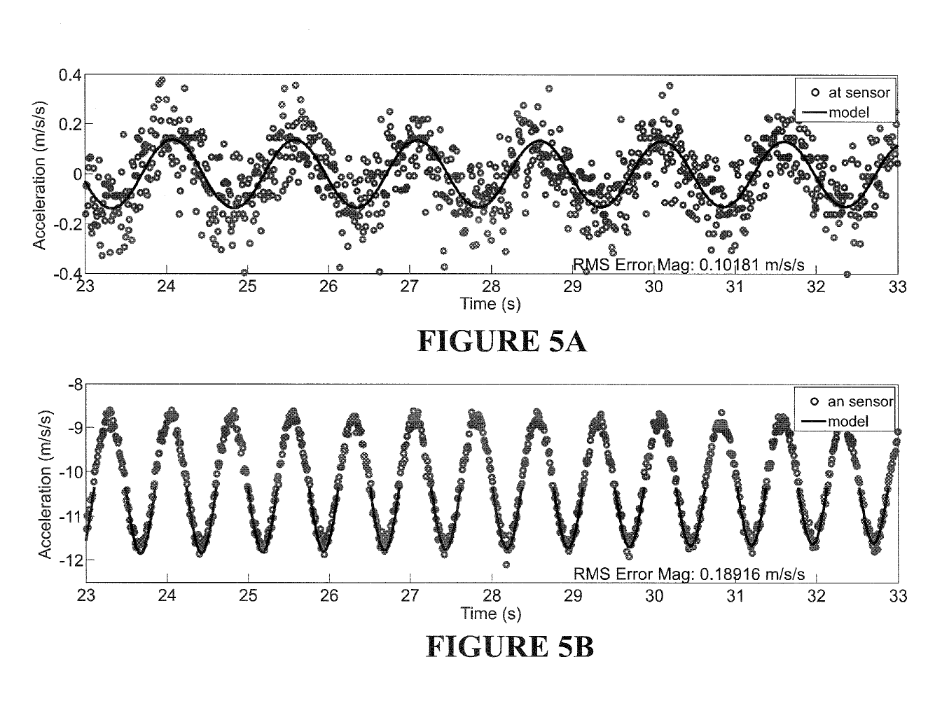

Two 40 s data sets (motion sensor and the encoder) were recorded and time-aligned using cross correlation techniques. The motion data was down-sampled to 100 Hz to match the sampling frequency of the encoder. The data was then input into the model, as discussed in the methods section; typical results can be seen in FIGS. 5a-7b. The RMS errors between the sensor data and the model were calculated and are displayed in the respective plot. Note that only a segment of 10 seconds is shown in the plots but the RMS error was calculated over the entire 40 second dataset.

The optimized degrees of freedom (system parameters of the dynamic motion model) are shown in Table 1:

| Degree of Freedom | Optimized value |
|---|---|
| l_{com} | 0.5482 m |
| lₛₑₙₛ | 0.5313 m |
| φ | 0.0029 kgm²s⁻¹ |

### Experiment Observations

Validation is an important issue when using models to approximate parameter values in real world systems. The validation process requires the outputs of the system to be compared to physically measureable metrics. The results shown in this experiment validate both the model developed and the technology used.

The optimized output for lₛₑₙₛ of 0.531 m was close to the physically measured length of 0.534 m. This shows us that the model was able to predict the position of the motion sensor within 1% of the physical measurement.

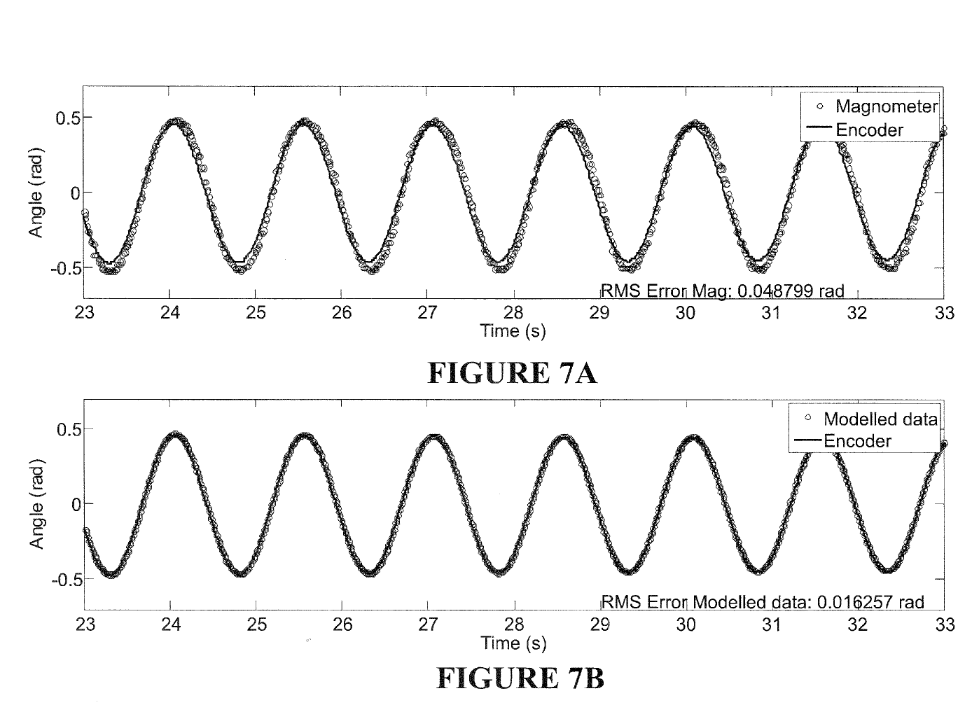

The accuracy of the model with respect to the sensor technology is shown in the comparison of the magnitude of the RMS errors between each of the parameters in the objective function. The fitted models all produce modest RMS errors. Further validation of the system comes from comparing both the raw sensor data and the optimized model to the ‘gold standard’ encoder. As shown an improvement in accuracy is gained from using the model in conjunction with the motion sensor technology. FIGS. 7a and 7b illustrate that using the model in conjunction with the motion sensor improves the estimate of angle by 67%, reducing the RMS error from 0.048799 rad (2.79°) to 0.016257 rad (0.9315°).

### Cycling Applications of the Motion Modelling System and Method

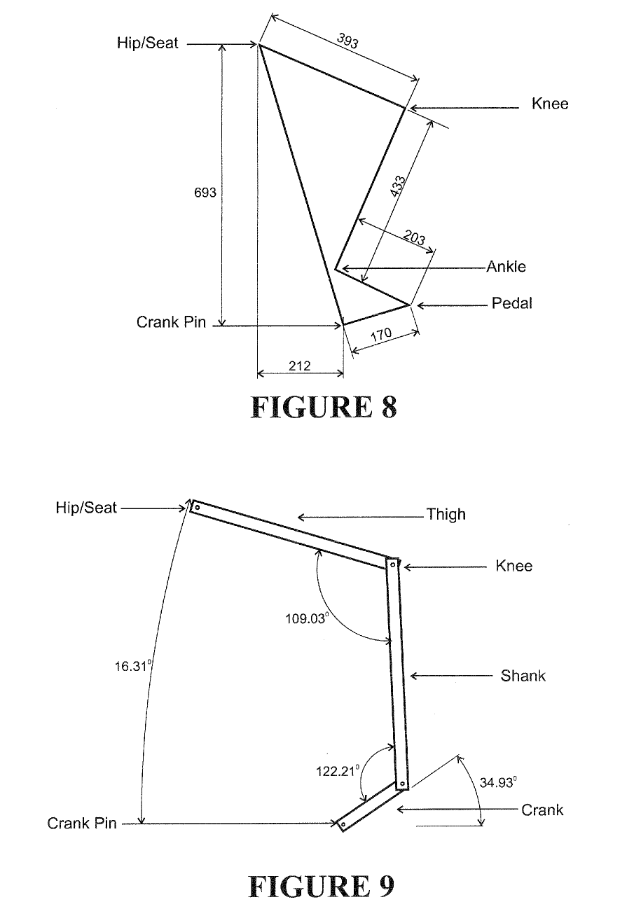

As discussed above, the system and method may be applied to any physical system in which the motion of moving features, components or parts of a physical system is desired to be modelled or assessed. By way of example, one example implementation of the system and method to a biomechanical model for modelling the motion of human limbs and in particular a cyclist's leg limb motion will be explained with reference to FIGS. 8 and 9.

A set of equations of motion (EOM) is derived for each limb, and a motion sensor is placed on each segment of that limb. There may be multiple motion sensors for each set of EOM, for example if you derived the equations of motion of a cyclists leg, you would have 2-3 motion sensors feeding data into the system of equations; where the motion sensors are placed on the upper leg (femur), lower leg (tibia/fibular), and (dependent on how many segments were defined in the EOM) on the foot.

As discussed, the outputs of the model can be used to drive any suitable mechanical system. Using cycling as an example, the model first determines optimal values associated with the degrees of freedom (unknown system parameters) which relate to different physical components of the system in question. Diagrams of example kinematic models of cyclists can be seen in FIGS. 8 and 9. Particular degrees of freedom related to the cycling model may include:
The lengths of each segment e.g. the distances from both the hip joint to the knee joint.
The position of each sensor on each segment e.g. the exact position of the sensor on upper leg.
Any dynamic properties of the joints joining segments (e.g. damping and spring coefficients of the knee joint).

Once the unknowns (system parameters) of the model have been defined/optimised, the kinematic model can be driven, in real time, by the motion sensors that are streaming live sensed motion data back to the base computer on which the model is running. In this particular case, angles calculated by the sensors will drive the kinematic model that describes the system (cycling). Furthermore once the system has been completely defined the user can alter physical parameters on the bike (which are mimicked in the kinematic model) to obtain optimum efficiency for the rider's technique. Practical applications may include:
1. The bicycle fitting process, where the bike is fitted to the specific rider. For example: There are some physical components on a bike that can be tweaked in order to alter the angles that are created at the hip, knee, and ankle joints. There is an optimal combination of angles wherein the cyclist achieves a maximum power output, whilst maintaining efficiency and desired physiological conditions in order to minimise stress' on associated joints and/or muscles. Using the model described in this document, a trainer can accurately measure the angles generated at the relevant joints and tweak the physical components to obtain that optimum combination of angles for the given rider. The system would require a sensor on each segment (in between two joints) and they would typically be placed somewhere on the segment that minimises movement associated with soft tissue deformation.
2. Monitoring the technique of a cyclist out on the road. For example: Being able to monitor the technique of a cyclist over the duration of a ride can provide valuable feedback to the rider and/or trainer. Once a kinematic model has been personalised for a rider (during the bike fit process) it can be uploaded onto their bike computer. The on-board computer would process and store the data streaming from the motion sensors so that it could be viewed and processed post ride, but also provide real time feedback to the cyclist. Real time feedback would compare the cyclist to specific metrics determined by their coach for example, which include, but are not limited to:
   a. Hip, knee, and/or ankle angle deviations from the optimal, it the form of flexion, extension, abduction, and/or adduction.
   b. disproportionate power output from different legs
   c. disproportionate angular velocities of each pedal stroke.

The foregoing description of the invention includes preferred forms thereof. Modifications may be made thereto without departing from the scope of the invention as defined by the accompanying claims.

1. A method of generating model motion data representing the predicted motion of a physical system based on sensed motion data from one or more motion sensors within the physical system, comprising:
generating a stream of model motion data representing the predicted motion of the physical system based on a dynamic motion model of the physical system which comprises initial estimates of system parameters;
receiving a stream of sensed motion data representing the measured motion within the physical system as sensed by the one or more motion sensors within the physical system;
optimizing the system parameters of the dynamic motion model based on processing of the streams of model motion data and sensed motion data; and
outputting the model motion data from the dynamic motion model based on the optimized system parameters.

2. A method according to claim 1 wherein the dynamic motion model of the physical system comprises a physical system model defined by equations of motion corresponding to the physical system.

3. A method according to claim 1 wherein generating model motion data comprises solving the equations of motion of the physical system model to generate one or more time-dependent model motion data variables.

4. A method according to claim 3 wherein the model motion data variables represent any position and/or orientation parameter relating to the motion within the physical system.

5. A method according to claim 1 wherein the physical system comprises one or more motion sensors located or mounted on moving features within the physical system and which are configured to sense or measure motion of those moving features within the physical system to generate sensed motion data.

6. A method according to claim 5 wherein each motion sensor comprises:
an accelerometer configured to sense acceleration and generate sensed motion data variables representing acceleration within the physical system;
a magnetometer configured to sense magnetic field strength and generate sensed motion data variables representing magnetic field strength within the physical system; and
a gyroscope configured to sense angular velocity and generate sensed motion data variables representing angular velocity within the physical system.

7. A method according to claim 1 wherein the dynamic motion model of the physical system further comprises a motion sensor relationship model that is configured to model the relationship between the model motion data from the physical system model and the sensed motion data from the one or more motion sensors.

8. A method according to claim 1 wherein optimizing the system parameters of the dynamic motion model comprises applying an objective function to the stream of model motion data and sensed motion data to generate optimized system parameters.

9. A method according to claim 8 wherein optimizing the system parameters comprises continuously or periodically optimizing the system parameters based on the continuous streams of model motion data and sensed motion data.

10. A motion assessment system for generating model motion data representing the predicted motion within a physical system, comprising:
a dynamic motion model sub-system that is configured to generate a stream of model motion data representing the predicted motion of the physical system based on a dynamic motion model of the physical system, the dynamic motion model being configured by model configuration data defining the dynamic motion model of the physical system being assessed and initial estimates of model system parameters;
one or more motion sensors within the physical system that are configured to measure motion within the physical system and generate a stream of sensed motion data representing the measured motion; and
an optimization sub-system configured to receive and process the streams of model motion data and sensed motion data so as to optimize the model system parameters of the dynamic motion model to improve the accuracy of the model motion data.

11. A motion assessment system according to claim 10 wherein the physical system comprises one or more motion sensors located or mounted on moving features within the physical system and which are configured to sense or measure motion of those moving features within the physical system to generate sensed motion data.

12. A motion assessment system according to claim 11 wherein the sensed motion data represents one or more sensed motion data variables representing motion within the physical system.

13. A motion assessment system according to claim 11 wherein each motion sensor comprises:
an accelerometer configured to sense acceleration and generate sensed motion data variables representing acceleration within the physical system;
a magnetometer configured to sense magnetic field strength and generate sensed motion data variables representing magnetic field strength within the physical system; and
a gyroscope configured to sense angular velocity and generate sensed motion data variables representing angular velocity within the physical system.

14. A motion assessment system according to claim 11 wherein each motion sensor comprises a global positioning system (GPS) sensor or module that is configured to sense position and/or linear velocity and generate sensed motion data variables representing the position and/or linear velocity within the physical system.

15. A motion assessment system according to claim 11 wherein each motion sensor is an accelerometer sensor, magnetometer sensor, gyroscope sensor, or GPS sensor, either alone or in any combination, and each sensor is configured to measure along 1, 2, or 3 axes, and where the axes are typically orthogonal to each other.

16. A motion assessment system according to claim 11 wherein the model configuration data defines a dynamic motion model comprising:
a physical system model that is configured to generate the model motion data representing the predicted motion of the physical system; and
a motion sensor relationship model that is configured to define the relationship between the model motion data of the physical system model and the sensed motion data from the motion sensor(s).

17. A motion assessment system according to claim 10 wherein the optimization sub-system is configured to apply an objective function to the model motion data and sensed motion data and generate optimized model system parameters that reduce any error between the motion as represented by the model motion data and sensed motion data.

18. A motion modeling device for modeling the motion of a physical system, comprising:
an input interface configured to receive a stream of sensed motion data from one or more motion sensors within the physical system that are configured to sense motion within the physical system;
a signal processor configured to generate a stream of model motion data representing the predicted motion within the physical system based on a dynamic motion model of the physical system, the dynamic motion model being configured by stored model configuration data defining the dynamic motion model of the physical system and stored initial estimates of system parameters within the dynamic motion model, the signal processor being configured to update the system parameters of the dynamic motion model with optimized system parameters generated based on processing of the streams of model motion data and sensed motion data;
memory configured to store system data used and processed by the signal processor; and
an output interface configured to output the model motion data.

19. A motion modeling device according to claim 18 wherein the signal processor is configured to continuously or periodically update the system parameters of the dynamic motion model with optimized system parameters.

20. A motion modeling device according to claim 18 wherein the signal processor is configured to apply an objective function to the streams of model motion data and sensed motion data and generate the optimized system parameters that reduce any error between the motion as represented by the model motion data and sensed motion data.
